(19) United States
(12) Patent Application Publication
(10) Pub. No.: US 2024/0119327 A1
(43) Pub. Date: Apr. 11, 2024

(54) SYSTEMS AND METHODS FOR QUANTUM SIMULATION WITH ANALOG COMPILATION

(71) Applicant: University of Maryland, College Park, College Park, MD (US)

(72) Inventors: Xiaodi WU, Brookline, MA (US); Yuxiang PENG, Greenbelt, MD (US); Jacob YOUNG, Riverdale, MD (US)

(21) Appl. No.: 18/140,856

(22) Filed: Apr. 28, 2023

Related U.S. Application Data
(60) Provisional application No. 63/363,897, filed on Apr. 29, 2022.

(51) Int. Cl. G06N 10/20

(52) U.S. Cl. CPC G06N 10/20

(57) ABSTRACT

Examples of the present disclosure provide systems and methods for performing quantum simulation. For example, such systems and methods may perform quantum simulation, at least in part, by obtaining a Hamiltonian equation and a selection of a target quantum device, accessing an abstract analog instruction set configured to cause an evolution in the selected target quantum device, and compiling the Hamiltonian equation to generate a pulse schedule based on the abstract analog instruction set for the target quantum device.

### CROSS-REFERENCE TO RELATED APPLICATION/CLAIM OF PRIORITY

This application claims the benefit of, and priority to, U.S. Provisional Patent Application No. 63/363,897, filed on Apr. 29, 2022, the entire contents of which are hereby incorporated herein by reference.

### GOVERNMENT SUPPORT

This invention was made with government support under DESC0020273 and DESC0019040 awarded by the U.S. Department of Energy (DOE). The government has certain rights in the invention.

### TECHNICAL FIELD

The present disclosure relates generally to the field of quantum computing and quantum information processing. More specifically, the present disclosure provides, for example, systems and methods for quantum simulation with analog compilation.

### BACKGROUND

Qubit-level quantum circuits have been adopted as the major abstraction for quantum computing, which is mathematically simple and works well as a mental tool for the theoretical study of quantum information. Because of that, many quantum programming languages have adopted quantum circuits as the only abstraction. While successful when working with quantum applications involving a handful of qubits, quantum circuit abstraction is conceivably hard to scale even when the user has, for example, hundreds of qubits, which already makes visualizing quantum circuits a hard task. Moreover, it also requires the specification of (qu)bit-level quantum operations, which needs strong quantum expertise, could change significantly for different hardware, and stays at a too-detailed level for domain experts.

Accordingly, there is interest in the benefits and applications of quantum simulation.

### SUMMARY

An aspect of the present disclosure provides a system for quantum simulation with analog compilation. The system includes a user interface, a processor, and a memory. The memory includes instructions stored thereon, which, when executed by the processor, cause the system to: obtain a Hamiltonian equation, obtain a selection of a target quantum device, access an abstract analog instruction set configured to cause an evolution in the selected target quantum device, and compile the Hamiltonian equation to generate a pulse schedule based on the abstract analog instruction set for the target quantum device.

In an aspect of the present disclosure, the instructions, when executed by the processor, may further cause the system to transmit the pulse schedule to the target quantum device to create an evolution in the target quantum device.

In an aspect of the present disclosure, the target quantum device may be one of a plurality of quantum devices.

In yet another aspect of the present disclosure, the pulse schedule may include one or more patterns of analog pulses.

In another aspect of the present disclosure, programming the target quantum device may include transmitting signals in the form of pulses through one or more signal carriers.

In another aspect of the present disclosure, the signals are configurable through parameters that may include amplitude over time and/or phase over time.

In yet another aspect of the present disclosure, the one or more signal carriers are abstracted as signal lines.

In yet another aspect of the present disclosure, each signal line may include instructions to represent the signals sent through the signal carriers.

In another aspect of the present disclosure, at each point in time the signal line may carry no more than one instruction of the instruction.

In yet another aspect of the present disclosure, when compiling the Hamiltonian equation, the instructions, when executed by the processor, may further cause the system to declare zero, one or more local variables that can be tuned for each invocation when compiling the target Hamiltonian.

In a further aspect of the present disclosure, Hamiltonians used in the Hamiltonian equation may be stored in a dictionary as linear combinations of product Hamiltonians.

In yet another aspect of the present disclosure, the analog instruction set may include one or more site identifiers in a set to represent qubit sites of the target quantum device.

In accordance with further aspects of the present disclosure, a processor-implemented method for quantum simulation is presented. The method includes obtaining a Hamiltonian equation, obtaining a selection of a target quantum device, accessing an abstract analog instruction set configured to cause an evolution in the selected target quantum device, and compiling the Hamiltonian equation to generate a pulse schedule based on the abstract analog instruction set for the target quantum device.

In yet another aspect of the present disclosure, the method may further include programming the target quantum device based on the pulse schedule.

In a further aspect of the present disclosure, the target quantum device may be one of a plurality of quantum devices.

In a further aspect of the present disclosure, the pulse schedule may include one or more patterns of analog pulses.

In yet another aspect of the present disclosure, programming the target quantum device may include transmitting signals in the form of pulses through one or more signal carriers.

In a further aspect of the present disclosure, the signals may be configurable through parameters including at least one of amplitude over time or phase over time.

In a further aspect of the present disclosure, the analog instruction set may include one or more site identifiers in a set to represent qubit sites of the target quantum device.

An aspect of the present disclosure provides a non-transitory computer-readable storage medium storing a program for causing a processor to execute a method of quantum simulation is presented. The method includes obtaining a Hamiltonian equation; obtaining a selection of a target quantum device, accessing an abstract analog instruction set configured to cause an evolution in the selected target quantum device, and compiling the Hamiltonian equation to generate a pulse schedule based on the abstract analog instruction set for the target quantum device.

Further details and aspects of exemplary aspects of the present disclosure are described in more detail below with reference to the appended figures.

### BRIEF DESCRIPTION OF THE DRAWINGS

A better understanding of the features and advantages of the present disclosure will be obtained by reference to the following detailed description that sets forth illustrative aspects, in which the principles of the present disclosure are utilized, and the accompanying drawings of which:

FIG. 1 is a diagram of an exemplary quantum system for quantum simulation with analog compilation, in accordance with examples of the present disclosure;

FIG. 2 is a schematic diagram of an exemplary processing system diagram for use with the system of FIG. 1, in accordance with examples of the present disclosure;

FIG. 3 is a diagram of the system of FIG. 1, in accordance with examples of the present disclosure;

FIG. 4 is an example illustrating an equation builder, in accordance with examples of the present disclosure;

FIG. 5 is an example of an equation system to synthesize H_{MIS} on an ideal Rydberg machine, in accordance with examples of the present disclosure;

FIG. 6 is an example of a conflict graph, in accordance with examples of the present disclosure;

FIG. 7 is a diagram of an example pulse schedule of the system of FIG. 1, in accordance with examples of the present disclosure;

FIG. 8 is a flow diagram of the system of FIG. 1, in accordance with examples of the present disclosure;

FIG. 9 is a diagram of a three-qubit Rydberg atom array, in accordance with examples of the present disclosure; and

FIG. 10 is a diagram of a superconducting system, in accordance with examples of the present disclosure; and

FIG. 11 is a diagram of a method for quantum simulation with analog compilation for the quantum system of FIG. 1, in accordance with examples of the present disclosure.

### DETAILED DESCRIPTION

The present disclosure relates generally to the field of quantum operations. More specifically, the present disclosure provides at least a system and method for quantum simulation with analog compilation.

Aspects of the present disclosure are described in detail with reference to the drawings wherein identical reference numerals identify similar or identical elements.

Although the present disclosure will be described in terms of specific examples, it will be readily apparent to those skilled in this art that various modifications, rearrangements, and substitutions may be made without departing from the spirit of the present disclosure. The scope of the present disclosure is defined by the claims appended hereto.

For the purpose of promoting an understanding of the principles of the present disclosure, reference will now be made to exemplary aspects illustrated in the drawings, and specific language will be used to describe the same. It will nevertheless be understood that no limitation of the scope of the present disclosure is thereby intended. Any alterations and further modifications of the novel features illustrated herein, and any additional applications of the principles of the present disclosure as illustrated herein, which would occur to one skilled in the relevant art and having possession of this disclosure, are to be considered within the scope of the present disclosure.

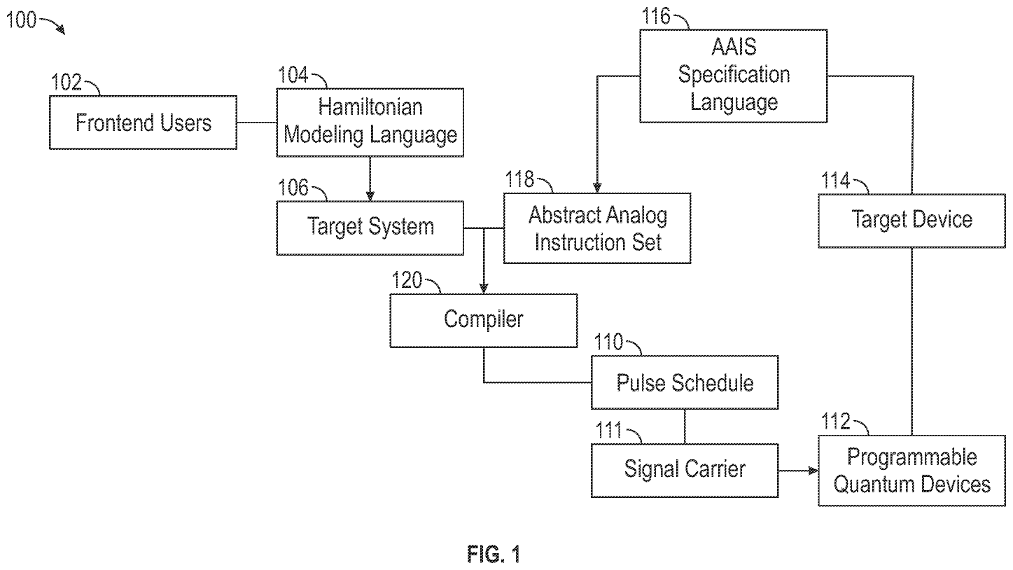

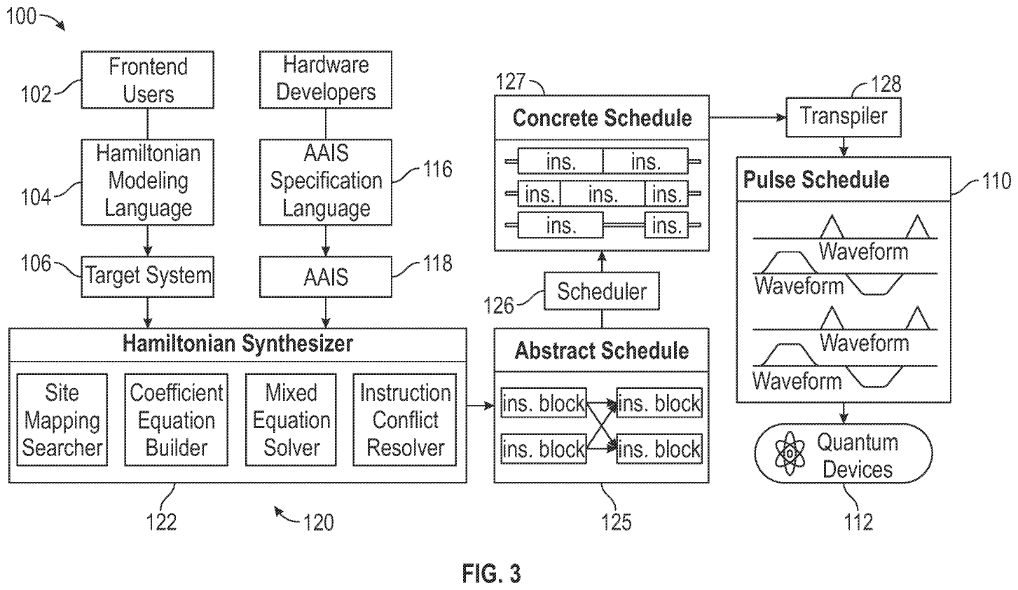

Referring to FIGS. 1 and 3, a diagram of an example system 100 for quantum simulation with analog compilation is shown. The system 100 generally includes a frontend 102, a Hamiltonian modeling language (HML) 104, an abstract analog instruction set (AAIS) specification language 116, a compiler 120, one or more signal carriers 111, and a target quantum device 112 (e.g., heterogeneous analog devices).

The compiler 120 is configured to generate an instruction schedule and a site mapping, such that the target system 106 is reproduced on the device's 112 subsystem specified by the site mapping. Then the compiler 120 translates the instruction schedule to executable pulses (pulse schedule 110) for the target quantum devices 112.

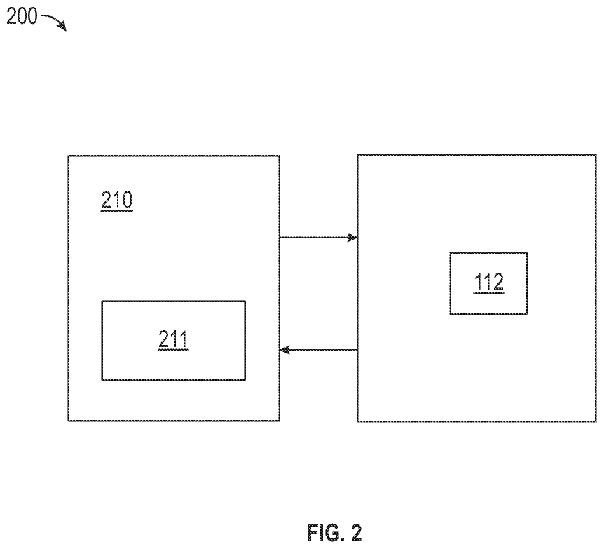

System 100 may include a controller 200 (FIG. 2) for operating the system 100. The controller 200 may be, for example, a user device such as a desktop computer, a laptop computer, a tablet, and/or a mobile device. In aspects, portions of system 100 may operate remotely on a server. For example, a user may enter a Hamiltonian on a user interface of a tablet, and the compiling may be performed remotely on a server. These are merely examples, and other portions of the system may be executed remotely or locally.

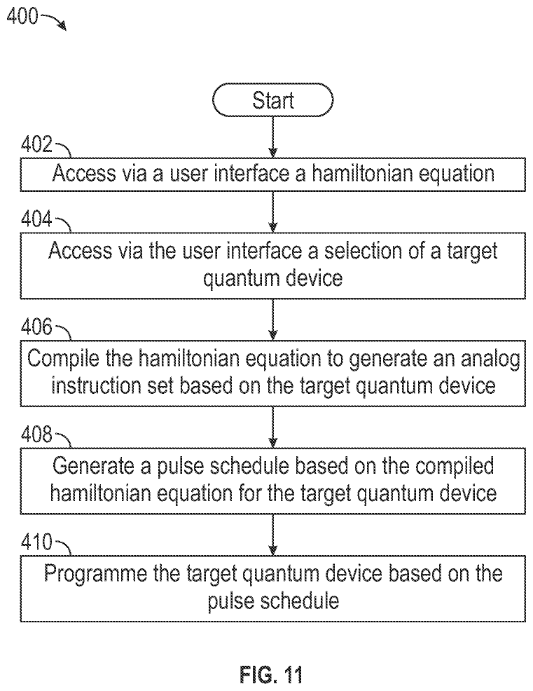

Referring to FIG. 2, an illustrative schematic for quantum simulation with analog compilation for the system 100 of FIG. 1 is shown. The system 200 for quantum simulation with analog compilation may include a processor 210 (FIG. 2) and a memory 211, including instructions stored thereon, which, when executed by the processor 210, cause the quantum system 100 to perform the steps of method 400 of FIG. 11.

The processor 210 may be connected to a computer-readable storage medium or a memory 211. The computer-readable storage medium or memory 211 may be a volatile type of memory, e.g., RAM, or a non-volatile type of memory, e.g., flash media, disk media, etc. In various aspects of the disclosure, the processor 210 may be any type of processor such as a quantum processor, a digital signal processor, a microprocessor, an ASIC, a graphics processing unit (GPU), a field-programmable gate array (FPGA), or a central processing unit (CPU).

In aspects of the disclosure, the memory 211 can be a quantum memory, random access memory, read-only memory, magnetic disk memory, solid-state memory, optical disc memory, and/or another type of memory. In some aspects of the disclosure, the memory 211 can be separate from the processor and can communicate with the processor through communication buses of a circuit board and/or through communication cables such as serial ATA cables or other types of cables. Memory 211 includes computer-readable instructions that are executable by the processor 210 to operate the processor. In other aspects of the disclosure, system 200 may include a network interface to communicate with other computers or to a server. A storage device may be used for storing data.

Referring again to FIGS. 1 and 3, flow diagrams of the system for quantum Hamiltonian simulation are shown. The disclosed system 100 provides the benefit of separating the description of the target Hamiltonian simulation, which is a physics object, from its implementation on specific quantum hardware, which consists of a schedule of instructions available on quantum devices 112. As a result, the domain experts can focus on describing the desired Hamiltonian simulation through a modeling programming language and leave the implementation, which can be a tedious and error-prone procedure, to be handled by the compiler 120 of system 100.

The disclosed technology provides the benefit of enabling compilation to general quantum devices 112 that are not gate-based. Indeed, recent experimental developments suggest that continuous-time analog quantum simulators could be advantageous over gate-based digital quantum simulation in the noisy intermediate-scale quantum (NISQ) era. Operations on these analog quantum simulators are pieces of specific Hamiltonian evolution on a small fraction of the system, which are controlled directly by continuous-time pulses rather than gates. In fact, all digital quantum gates are eventually implemented by pulses in a similar way. However, by breaking the gate abstraction and allowing a direct compilation to pulses, resources could be saved, which is critical for the performance of NISQ devices. The present disclosure develops a compilation procedure to leverage this benefit for Hamiltonian simulation, which would also work with analog quantum simulators that are based on different physical implementations.

Mathematically, Hamiltonian simulation refers to evolving a quantum state |ψ(t) [symbol] , which is a high-dimensional complex vector, according to the Schrödinger equation:

$$\frac{d}{d t} \vert ψ ( t ) 〉 = - i H ( t ) \vert ψ ( t ) 〉 \qquad ( Eqn . 1 )$$

where H(t) is generally a time-dependent Hermitian matrix, also known as the Hamiltonian governing the system. For an n qubit system, the dimension of both H(t) and |ψ(t) [symbol] could be 2ⁿ, which makes its classical simulation exponentially difficult. However, by carefully scheduling available instructions on a quantum device, one could let the quantum device simulate the target Hamiltonian H(t) with the device's own Hamiltonian evolution, incurring minimal overhead.

There are a few design choices and technical challenges toward the development of the new abstraction, associated domain-specific language, and its compilation.

The first challenge is the precise modeling of Hamiltonian simulation and potentially heterogeneous analog devices. The former is intuitive as the object of interest is H(t), whereas its exponential-size matrix expression is less desirable due to the scalability. H(t) is the sum of Hamiltonians that are tensor products of local ones, which leads to a very succinct description that is yet rich enough to express many interesting quantum many-body systems for simulation.

The modeling of analog quantum devices is much more challenging. Unlike the gate model, where the fundamental primitives are a finite number of one or two-qubit unitary, analog quantum devices are usually described by one global Hamiltonian, which differs significantly device by device. As used herein, Abstract Analog Instruction Set (AAIS) describes the programmability of heterogeneous analog devices. Signal lines model carriers of analog signals, each of which could carry different patterns of analog pulses that are abstracted as parameterized analog instructions. These parameterized analog instructions would then implement pieces of Hamiltonian simulations on some fraction of the system, the collection of which is a representation of the programmability of the analog device.

The second challenge is the compilation of analog quantum devices 112. In the digital setting, the primitive gates are small-dimensional matrices, and the compilation of large quantum evolution into these gates could be done with an analytical formula (e.g., the Solovay-Kitaev theorem). In the analog setting, the effect of performing an instruction ι with parameter valuation v is described as a time-independent Hamiltonian H_{(ι,v)}. An analog instruction schedule [symbol] assigns signal line L to one instruction ι with a valuation v (denoted as [symbol] (L,t)=(ι,v)) at any time t, whose total effect is the summation of effects from all signal lines, i.e., [symbol] (t)=Σ_{L} [symbol] _{(L,t)}. The goal of the compilation is to match [symbol] (t) with H(t), which are handled as symbolic pattern matching inspired by the seminal work in classical analog compilation. This restriction improves the scalability of the compilation, which, however, ignores possible instruction schedules whose validity relies on the matrix semantics of [symbol] (t) and H(t).

Given a valid instruction schedule [symbol] , the last challenge is to convert [symbol] into the actual pulses executable on target devices, which is not readily supported by any existing quantum programming tool chain, and generate the desired pulse shapes for a plurality of quantum devices.

In the following example, system 100 is used to encode a Hamiltonian simulation problem in the Hamiltonian modeling language, utilize an AAIS describing a Rydberg atom quantum system, and generate the resulting pulses for machine execution.

A qubit (or quantum bit) is the analog of a classical bit in quantum computation. A qubit is a two-level quantum-mechanical system described by the Hilbert space [symbol] ². The classical bits “0” and “1” are represented by the qubit states

$$\vert 0 〉 = [ \begin{matrix}1 \\ 0\end{matrix} ] and \vert 1 〉 = [ \begin{matrix}0 \\ 1\end{matrix} ] ,$$

and linear combinations of |0 [symbol] and |1 [symbol] are also valid states, forming a superposition of quantum states. An n-qubit state is a unit vector in the Kronecker tensor product ⊗ of n single-qubit Hilbert spaces, i.e., [symbol] =⊗ᵢ₌₁ⁿ [symbol] ²≅ [symbol] ²^{ⁿ}, whose dimension is exponential in n. For an n by m matrix A and a p by q matrix B, their Kronecker product is an np by mq matrix where (A⊗B)_{pr+u,qs+v}=A_{r,s}B_{u,v}. The complex conjugate transpose of |ψ [symbol] is denoted as [symbol] Ψ|=|Ψ [symbol] ^{†} († is the Hermitian conjugate). Therefore, the inner product of ϕ and Ψ could be written as [symbol] ϕ|Ψ [symbol] .

The time evolution of quantum states is specified by a time-dependent Hermitian matrix H(t) over the corresponding Hilbert space, known as the Hamiltonian of the quantum system. Typical single-qubit Hamiltonians include the famous Pauli matrices:

$$I = [ \begin{matrix}1 & 0 \\ 0 & 1\end{matrix} ] , X = [ \begin{matrix}0 & 1 \\ 1 & 0\end{matrix} ] , Y = [ \begin{matrix}0 & - i \\ i & 0\end{matrix} ] , Z = [ \begin{matrix}1 & 0 \\ 0 & - 1\end{matrix} ] . \qquad ( Eqn . 2 )$$

Specifically, the number operator \hat{n}=(I−Z)/2 determines if the state is in |1 [symbol] . A multi-qubit Hamiltonian can be a linear combination of product Hamiltonians—tensor products of Pauli matrices. By convention, Xⱼ is a multi-qubit Hamiltonian to indicate I⊗ . . . ⊗I⊗X⊗I⊗ . . . ⊗I, where the j-th operand is X. Similarly, Yⱼ and Zⱼ represent operations on the j-th subsystem. The time evolution obeys the Schrodinger equation (eqn. 1).

Physically, operators in Hamiltonians correspond to physics effects like the influence of electrical or magnetic fields. Scalar multiplication (e.g., 2·X) changes the effect strength: if strength doubles, the time to achieve the same evolution is halved. Additions of operators (e.g., X₁+X₂) represent simultaneous physics effects, e.g., the superposition of forces. Multiplications of operators (e.g., X₁X₂) represent the interactions across different sites.

Quantum measurement refers to the process of extracting classical information from quantum systems. When applied to state |ϕ [symbol] , with probability | [symbol] s|ϕ [symbol] |², quantum measurement reports the bit-string s and collapses the quantum state |ϕ [symbol] to a classical state |s [symbol] =|s₁ [symbol] ⊗|s₂ [symbol] ⊗ . . . ⊗|sₙ [symbol] .

Quantum simulation reproduces the evolution of a target quantum system on another programmable quantum device or system (e.g., a backend). Suppose the target system evolves under Hamiltonian H(t) over Hilbert space [symbol] ₁ and there exists a need to simulate the target system on the backend, whose Hilbert space is [symbol] ₂. A subspace [symbol] ₂′⊂ [symbol] ₂ satisfying [symbol] ₁≅ [symbol] ₂, a linear mapping [symbol] : [symbol] ₁→ [symbol] ₂′, and a programmed evolution on the backend where the evolution limited in [symbol] ₂′ is governed by [symbol] (H(t)) may be found.

Consider an example where the user wants to simulate a three-qubit system evolving under a time-independent Hamiltonian,

Hₜₐᵣ(t)=−(\hat{n}₁+\hat{n}₂+\hat{n}₃)+2(X₁+X₂+X₃)+4(\hat{n}₁\hat{n}₂+\hat{n}₂\hat{n}₃) (Eqn. 3)

for time duration t∈[0,1].

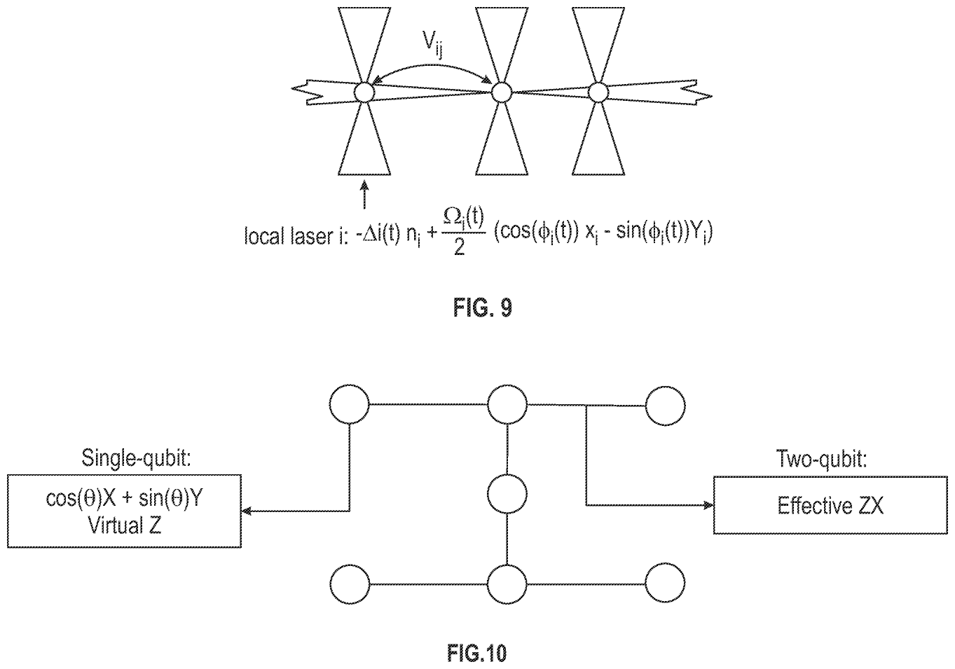

The user would like to compile this system to an ideal three-qubit Rydberg atom array as the backend (FIG. 9). Configurable Rydberg atoms arrays are one of the most promising quantum platforms towards computational advantages, where neutral atoms are placed on a plane and interfered with by laser beams. On the backend, the positions of atoms can be arbitrarily configured. Between a pair of atoms, there are van der Waals forces attracting the pair of atoms. Written in quantum mechanics, the force between the atom i and j is a Hamiltonian term:

$${H}_{sys}^{( i , j )} ( t ) = \frac{C}{{d}^{6} ( i , j )} {\hat{n}}_{i} {\hat{n}}_{j} \qquad ( Eqn . 4 )$$

where the Rydberg interaction constant C≈5.42×10⁶ MHz·μm⁶ and d(i,j) is the distance between the two atoms. To interfere with the three-qubit Rydberg atom array, the backend has three laser beams, each targeting one of the atoms. The laser beam i is configured by three functions \tilde{Δ}ᵢ(t), \tilde{Ω}ᵢ(t) and \tilde{ϕ}ᵢ(t), representing the detuning, the amplitude, and the phase of the laser. The laser beam interacts with the i-th atom according to a Hamiltonian term:

$${H}_{las}^{( i )} ( t ) = - {\tilde{Δ}}_{i} ( t ) {\hat{n}}_{i} + \frac{{\tilde{Ω}}_{i} ( t )}{2} ( cos ( {\tilde{ϕ}}_{i} ( t ) ) {X}_{i} - sin ( {\tilde{ϕ}}_{i} ( t ) ) {Y}_{i} ) \qquad ( Eqn . 5 )$$

Overall, configuring the backend using atom positions {\vec{x}ᵢ} and laser {(\tilde{Δ}ᵢ(t),\tilde{Ω}ᵢ(t),\tilde{ϕ}ᵢ(t))}, the system evolves under the Hamiltonian:

H_{backend}(t)=Hₗₐₛ⁽¹⁾(t)+Hₗₐₛ⁽²⁾(t)+Hₗₐₛ⁽³⁾(t)+H_{sys}^{(1,2)}(t)+H_{sys}^{(2,3)}(t)+H_{sys}^{(1,3)}(t) (Eqn. 6)

To simulate Hₜₐᵣ using the ideal Rydberg atom backend, a configuration is easily generated. However, when the system size grows, or machine effects become complicated for different architectures, manual generation tends to be impossible. The disclosed system 100 automates the compilation of quantum simulation.

Hₜₐᵣ(t) in the Python implementation of the Hamiltonian Modeling Language (HML) is programmed. The program starts by specifying a quantum system QS and N=3 qubit sites stored in q. Passing QS into their initialization denotes them as sites of QS. Each qubit site contains fields representing the operators I, X, Y, and Z, and \hat{n}ᵢ is created for each i with the expression (q[i].I−q[i].Z)/2.

Next, Hₜₐᵣ(t) is composed using these operators. The present disclosure starts with an empty Hamiltonian h, programs each term in Hₜₐᵣ, and adds them into h. In the implementation of system 100, Hamiltonians are stored in a dictionary as linear combinations of product Hamiltonians. For example, the operator \hat{n}₁\hat{n}₂=(I−Z₁)/2·(I−Z₂)/2=(Z₁Z₂−Z₁−Z₂+I)/4 is stored as:

{Z₁Z₂:¼, Z₁:−¼, Z₂:−¼, I:¼} (Eqn. 7)

Without ambiguity, the dictionary representation is overloaded to denote the coefficients of product Hamiltonian in a Hamiltonian, e.g., write \hat{n}₁\hat{n}₂[Z₁Z₂]=¼.

After programming Hₜₐᵣ(t) in h, the disclosure adds the evolution under time-independent Hamiltonian Hₜₐᵣ(t) for duration T to the quantum system QS, where T=1 microsecond.

Different architectures of programmable quantum devices have vastly different physics and specifications. To have an automated system 100 for all kinds of devices, the AAIS 118 captures the capabilities of analog quantum devices 112.

The common concepts for quantum devices are abstracted first. Normally, there are signal carriers attached to a quantum device. Signals in the form of pulses (time-dependent functions) are sent through the carriers and create effects on the device. The effects may be direct or effective. Direct effects depict in every detail how the system changes according to signals. However, the devices are often too complicated to describe, and hardware developers design engineered pulses such that the pulses effectively generate simple effects. These signals are also configurable through parameters like amplitudes and phases over time. Besides, there may be inherent dynamics of the quantum devices induced by the physics of the architecture. Overall, the evolution of the device obeys the Hamiltonian determined by signals' effects and inherent dynamics.

In an AAIS, signal carriers are abstracted as signal lines. Each signal line may contain several instructions to represent the signals sent through the carrier, and each time the signal line carries no more than one instruction. Instructions have properties distinguishing their compatibility with other instructions decided by their effects. Instructions causing direct effects are native, and those causing effective effects are derived. Derived instructions should not be simultaneously applied with other instructions affecting shared sites since there might be crosstalks induced by the detailed implementation implicit in AAIS. To further configure the instructions, several local variables are declared for each instruction that can be tuned for each invocation to generate a variety of effects. With a valuation of these variables, the effect of the instruction is described by an instruction Hamiltonian. When invoking many instructions at the same time, their instruction Hamiltonians are summed up to constitute the Hamiltonian governing the evolution of the device. For those global configurable parameters and inherent dynamics, they are modeled as global variables and system instructions, which are configured and fixed for the whole evolution.

The present disclosure includes a Rydberg AAIS designed for the ideal Rydberg system backend. The positions of atoms (assumed to be 1-D) in the ideal backend are configurable in the pre-experiment stage and unchangeable after evolution starts. They are modeled as global variables xᵢ, and the internal van der Waals forces are modeled as a system instruction ι_{sys} whose instruction Hamiltonian is:

H_{ι}_{_{sys}}(t)=Σ_{1≤i<j≤3}C/(xᵢ−xⱼ)⁶\hat{n}ᵢ\hat{n}ⱼ (Eqn. 8)

The laser beams have direct effects on the system based on the parameters. For each laser beam, a signal line Lᵢ and an instruction ιᵢ containing three local variables Δᵢ, Ωᵢ, and ϕᵢ is declared. The instruction Hamiltonian is then:

H_{ι}_{ᵢ}_{,v}_{ᵢ}(t)=−Δᵢ\hat{n}ᵢ+Ωᵢ/2·(cos(ϕᵢ)Xᵢ−sin(ϕᵢ)Yᵢ) (Eqn. 9)

where Δᵢ, Ωᵢ and ϕᵢ use their valuation from vᵢ.

The quantum machine is defined under the variable Rydberg, and qubit sites belonging to the system are declared and stored in list q. Next, the number of operators for the qubit sites in algebraic expressions is defined. Then the atom coordinates in the 1-D space of the ideal Rydberg machine are set as global variables stored in list x (unit: μm) and the coordinate of the first atom is fixed at 0. The system instruction H_{ι}_{_{sys}}(t) is constructed with each H_{sys}^{(i,j)} term, adding them to h and setting h as a system Hamiltonian. The i-th laser beam is modeled by a signal line Lᵢ and packaged with the effect H_{ι}_{ᵢ}_{,v}_{ᵢ}(t) into an instruction ιᵢ. The local variables are declared belonging to ιᵢ, corresponding to the three parameters respectively, and stored in Δ, Ω, and ϕ. ιᵢ is a native instruction since its effect is direct, and its instruction Hamiltonian is defined by its variables and site operators of the system.

For an instruction schedule [symbol] where [symbol] (Lᵢ,t)=(ιᵢ,vᵢ(t)) contains the instruction of signal line Lᵢ and valuation vᵢ(t) for variables Δᵢ, Ωᵢ, and ϕᵢ, the overall effect when applying [symbol] on the machine then i:

[symbol]

(t)=H_{ι}_{_{sys}}(t)+Σᵢ₌₁^{N} [symbol] _{(L}_{ᵢ}_{,t)} (Eqn. 10)

AAIS design is interoperable with, for example, IBM's® superconducting systems (FIG. 10) and IonQ's® trapped ion systems, amongst others.

Interoperability is formed by creating a signal line Lᵢ corresponding to the driving microwave for the i-th qubit, containing a native instruction ιᵢ^{X-Y} with local variables α and θ. Zᵢ evolution is effectively achieved by tuning phases of future microwaves, hence it cannot be activated simultaneously with other instructions. This is declared as a derived instruction ιᵢ^{Z} belonging to Lᵢ realizing αZᵢ with variable α.

Two-qubit interactions are realized by echoing cross-resonance microwaves, effectively approximating evolution under ZᵢXⱼ for neighboring i,j in the machine topology. Together with single qubit evolution, this interaction can realize XᵢXⱼ, YᵢYⱼ, or ZᵢZⱼ. For any edge (i,j) in the machine topology graph E, a signal line Lᵢⱼ is created with three derived instructions realizing αPᵢPⱼ for P∈{X, Y, Z} respectively.

For an N-qubit machine with topology E, the total effect of a schedule S is:

[symbol]

(t)=Σᵢ₌₁^{N} [symbol] _{(L}_{ᵢ}_{,t)}+Σ_{(i,j)∈E} [symbol] _{(L}_{ᵢⱼ}_{,t)} (Eqn. 11)

Interoperability may also be formed by using lasers to create ion potential traps, determining the single qubit (cos(θ)Xᵢ+sin(θ)Yᵢ) evolution, Zᵢ rotations, and XᵢXⱼ evolution between arbitrary two qubits, and using to realize YᵢYⱼ and ZᵢZⱼ evolutions, resulting in 2-qubit instructions between every pair of qubits.

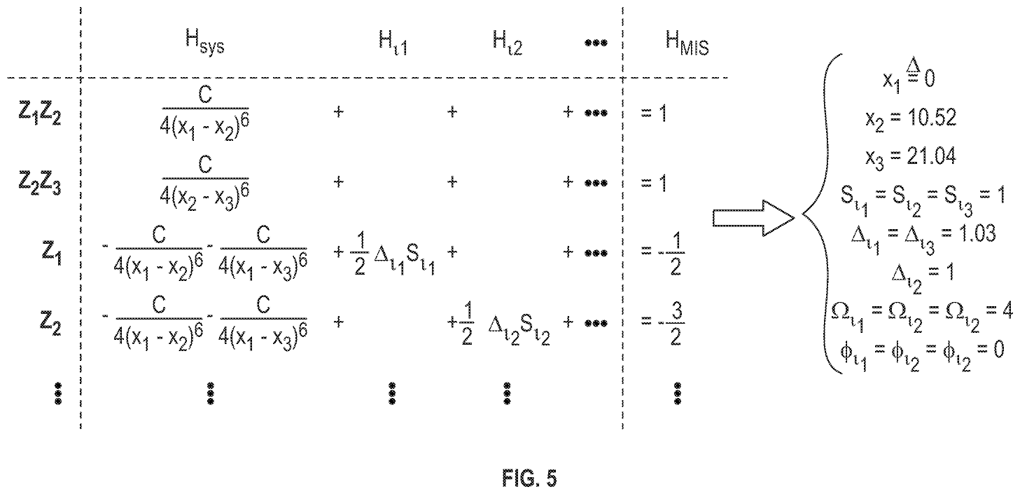

Referring to FIG. 5 a diagram illustrating the equation system to synthesize H_{MIS} on the ideal Rydberg machine and the solution to the equation system is shown. The compilation of Hₜₐᵣ to the ideal Rydberg backend uses several steps.

The first step is to map the Hilbert space of the target system to a subsystem of the ideal Rydberg backend. A site-to-site trivial mapping [symbol] may suffice, but not always for complicated cases. Hence, in general, the site must be searched for mapping.

To synthesize Hₜₐᵣ, the compiler 120 enumerates product Hamiltonians (e.g., a singleton Z₁) of Hₜₐᵣ and searches for their presence. Compiler 120 builds an equation system by the coefficients of the product Hamiltonians, as illustrated in FIG. 5. For instance, Z₁ appears in H_{ι}_{_{sys}} and

$${H}_{{ι}_{1} , {v}_{1}} ,$$

whose coefficients are:

$${H}_{{i}_{sys}} [ {Z}_{1} ] = - \frac{C}{4 {( {x}_{1} - {x}_{2} )}^{6}} - \frac{C}{4 {( {x}_{1} - {x}_{3} )}^{6}} , \\ {H}_{{i}_{1} , ( {Δ}_{{i}_{1}} , {Ω}_{{i}_{1}} , {ϕ}_{{i}_{1}} )} [ {Z}_{1} ] = \frac{{Δ}_{{i}_{1}}}{2} \qquad ( Eqn . 12 )$$

Here x₂ and x₃ are the global variables (x₁ is set to be 0) and Δ_{ι}_{₁} is the local variable of ι₁. To model whether this instruction is activated, switch variables are defined as s_{ι}_{₁}∈{0,1}. Then the compiler 120 builds an equation for Z₁ as:

$${H}_{{i}_{sys}} [ {Z}_{1} ] + {H}_{{i}_{1}} [ {Z}_{1} ] {s}_{{i}_{1}} = 𝒜 ( {H}_{tar} ) [ {Z}_{1} ] - \frac{C}{4 {( {x}_{1} - {x}_{2} )}^{6}} - \frac{C}{4 {( {x}_{1} - {x}_{3} )}^{6}} + \frac{{Δ}_{{i}_{1}}}{2} \cdot {s}_{{i}_{1}} = - \frac{1}{2} \qquad ( Eqn . 13 )$$

A mixed-binary non-linear equation solver is leveraged to obtain an approximate solution to the constructed equation system, with solutions presented in FIG. 5. The solution is interpreted as an instruction schedule [symbol] on the backend. The atom positions are set by the valuation of x₁, x₂, x₃. Notice s_{ι}_{₁}=s_{ι}_{₂}=s_{ι}_{₃}=1, so all the instructions are activated during time [0,1]. For the i-th laser, constant functions over time are created with values Δ_{ι}_{ᵢ}, Ω_{ι}_{ᵢ} and ϕ_{ι}_{ᵢ} corresponding to the parameter pulses.

The solution schedule [symbol] passes to Eqn. 10, and the synthesized Hamiltonian is obtained:

[symbol]

(t)=−(1.03\hat{n}₁+\hat{n}₂+1.03\hat{n}₃)+2(X₁+X₂+X₃)+(4\hat{n}₁\hat{n}₂+4\hat{n}₂\hat{n}₃+0.06\hat{n}₁\hat{n}₃)= [symbol] (Hₜₐᵣ)+0.016·(Z₁Z₃−I) (Eqn. 14)

The synthesis difference, 0.016·(Z₁Z₃−I), is small, and the theoretical bounds on the evolution error are induced by this difference.

The compiler 120 generates a program for schedule [symbol] . This pulse program can be executed on neutral atom machines. In order to depict the simulation problem and the backend machine, two domain-specific languages are used by the system 100: Hamiltonian Modeling Language (HML) to model the quantum systems and dynamics and AAIS Specification Language to specify AAISs of machines.

In order to describe a target physical system in a lightweight and expressive way, a Hamiltonian Modeling Language (HML) is proposed. Many abstractions are introduced in this language, including sites and site-based representations of Hamiltonians. For example, the language may be implemented in Python, with its abstract syntax and denotational semantics. Although Python is used as an example, other languages are contemplated to be within the scope of the present disclosure.

Initially sites and their operators in the target system are introduced. A qubit site is a quantized 2-level physical entity, for example, atoms with 2 energy levels. In HML, site identifiers are collected in a set Site, each representing a site of the system. Four operators, I, X, Y, and Z, are defined to represent the Pauli operators, and they are used as site operators. The X operator of qubit q i denoted as q.X and the other operators in a similar way.

A time-independent Hamiltonian is effectively a Hermitian matrix and is programmed by algebraic expressions. The basic elements of expressions are site operators A.R and scalars S. The common operations are collected between scalars in the definition of S.

An evolution P is then programmed in HML as a sequence of pairs (M,t) of a time-independent Hamiltonian H programmed as M and its evolution time t. Such a sequence in P represents a sequential evolution under each H for time t, and overall, an evolution under a piecewise constant Hamiltonian. In many-body physics systems, Hamiltonians are commonly continuous. These Hamiltonians are discretized into a series of piecewise constant Hamiltonians by evaluating them over a discrete list of time, realized as syntactic sugars with user-specified precision, and then programmed in HML.

The denotational semantics of a program P in HML is interpreted as a unitary matrix by [symbol] P [symbol] . Let h_{M} translate program M into Hermitian matrices by evaluating the expressions. Then [symbol] M [symbol] is the product of unitary matrices e^{-ith}^{_{M}}, each representing the solution to the Schrödinger equation under H(τ)=h_{M} for time duration t. This is the solution to the Schrödinger equation of the piecewise constant Hamiltonian evolution represented by P.

An abstract analog instruction set conveys the capability of a quantum device, which is essential machine information for the synthesis of target Hamiltonians. The abstract analog instruction contains abstract sites, the signal lines, and the possible instructions on each signal line.

An AAIS contains site identifiers in Site to represent qubit sites, and site operators are defined in the same syntax in AAIS Specification Language as in HML. Quantum machines have tunable parameters. Variables are designed corresponding to the parameters on the real machine and divided into two types: global variables and local variables. Global variables are set before evolution and fixed for later simulations. Local variables are tunable for each constant Hamiltonian evolution. Variable identifiers may be stored in LocalVar and GlobalVar in AAIS specification language. They are invoked in parameterized scalars and Hermitians, and their values will be filled during compilation.

In AAIS Specification Language, an instruction is effectively a parameterized Hermitian M decorated by the signal line L to which M belongs and its property U. Signal line identifiers are stored in “SigLine,” and each of the signal line identifiers models a carrier of signals, the media for different kinds of analog signals sent to quantum devices. Instructions are broadly sorted into three categories: native, derived, and system instructions, and are distinguished by instruction properties U∈Property={nat,der,sys}, decorating the instructions. A native instruction corresponds to procedures with direct physical effects. It can be activated simultaneously with other instructions and superposes effects on the system. A derived instruction realizes an effective Hamiltonian H via an indirect reproduction of H, hidden from the AAIS. It may crosstalk with other instructions when they both influence one or more sites simultaneously, resulting in non-superposition effects. For some devices, there exists a non-negligible system Hamiltonian. The non-negligible system Hamiltonian is modeled as a system instruction of a standalone system signal line, which can be activated simultaneously with other native instructions. The governance of instructions over local variables in AAIS Specification Language is not limited, although in the applications, a local variable only appears in one instruction.

An analog machine is programmed as a list of instructions. These instructions fully describe the capabilities of a device and abstract away pulse implementation details. Because these underlying details are typically complex, the design and programming of an AAIS should be carried out by device developers.

Machines P may be interpreted in AAIS Specification Language via {|⋅|} into a list of instructions represented by a tuple consisting of Hamiltonian H, signal line L, and property U, which is sufficient for the compiler 120 to generate instruction schedules. The function e̅v̅a̅l̅(⋅) for AAIS Specification Language is an extension of eval(⋅) in HML, where e̅v̅a̅l̅(S) represents a function taking a valuation of variables and generating a real number. A parameterized Hermitian M is translated into h_{M}, which is a function taking a variable valuation and generating a Hermitian. Letting {|ι|}=h_{M} represents the parameterized Hermitian of instruction ι=M^{L,U}.

An instruction schedule [symbol] describes what a machine executes at a given time. Formally, [symbol] (L,t)=(ι,v) displays the instruction ι to carry for signal line L at time t and a valuation v of variables. If signal line L carries no instruction at time t, [symbol] (L,t)=⊥. The validity of an instruction schedule is formally defined thereafter.

Definition 1. The influencing sites of M as inf(M), defined by

$$\begin{matrix}inf ( S \cdot M ) = inf ( M ) , & inf ( A . R ) = \{ A \} , \\ inf ( {M}_{1} + {M}_{2} ) = inf ( {M}_{1} ) ⋃ inf ( {M}_{2} ) , & inf ( {M}_{1} * {M}_{2} ) = inf ( {M}_{1} ) ⋃ inf ( {M}_{2} )\end{matrix} .$$

Two instructions ι₁=M₁^{L}^{₁}^{,U}^{₁} and ι₂=M₂^{L}^{₂}^{,U}^{₂} conflict with each other either if L₁=L₂, or if inf(ι₁)∩inf(ι₂)≠{ } and der∈{U₁,U₂}.

An instruction schedule [symbol] is invalid if two conflicting instructions are activated simultaneously. Formally, for a valid [symbol] , any t and L₁≠L₂, let [symbol] (L₁,t)=(M₁^{L}^{₁}^{,der},v₁) and [symbol] (L₂,t)=(M₂^{L}^{₂}^{,U}^{₂},v₂), there is inf(M₁)∩inf(M₂)={ }.

It is assumed that any derived instruction ι=M₁^{L}^{₁}^{,der} does not have any side effect: the derived instruction does not crosstalk with another instruction ι′=M₂^{L}^{₂}^{,U} where inf(M₁)∩inf(M₂)={ }.

Referring again to FIG. 3, the synthesis of a time-independent Hamiltonian Hₜₐᵣ evolves for time duration T given a machine AAIS ι₁; . . . ; ιₘ. The Hamiltonian synthesizer 122 follows a four-step process: (1) find a site mapping [symbol] ; (2) build a coefficient equation system; (3) solve the mixed-binary equation system; (4) resolve conflicting instructions.

A brute-force search with pruning is applied to find a site mapping [symbol] from the target system sites to the machine sites. [symbol] (H) is defined for Hamiltonian H under mapping [symbol] . The search is pruned by enforcing that, for product Hamiltonian P such that Hₜₐᵣ[P]≠0, there exists 1≤j≤m such that {|ιⱼ|}[ [symbol] (P)]≠0. The aborting condition can be met halfway in the search, where [symbol] (P) does not exist in the machine when limited to the already-searched sites. Whenever the search completely constructs a site mapping, continue to the next steps and check the feasibility of this site mapping. If an instruction schedule is found, the compilation succeeds. If none of the searched site mappings are feasible, the compiler 120 reports no possible solution.

Instructions and valuations of variables are synthesized to realize Hₜₐᵣ by building and solving a system of mixed-binary non-linear equations. A switch variable s_{ι}∈{0,1} for instruction ι indicates if ι is activated. For each product Hamiltonian P in [symbol] (Hₜₐᵣ) and {|ιⱼ|},

Σⱼ₌₁^{m}{|ιⱼ|}[P]·s_{ι}_{ⱼ}= [symbol] (Hₜₐᵣ)[P] (Eqn. 15)

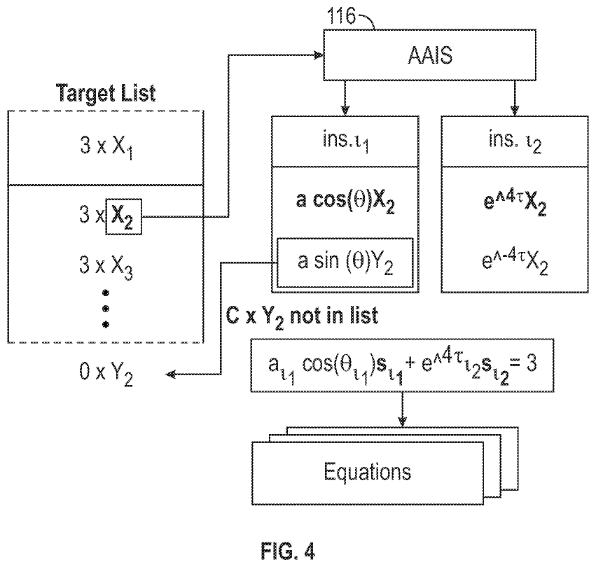

For a system Hamiltonian ι_{sys}, set s_{ι}_{_{sys}}=1. A heuristic algorithm, Algorithm 1, finds all non-trivial equations (where [symbol] (Hₜₐᵣ)[P]≠0 or no instruction ι such that {|ι|}[P]≠0 may activate). This algorithm starts with a list Q containing all the product Hamiltonians that may correspond to a non-trivial equation. At first, it contains every product Hamiltonian in [symbol] (Hₜₐᵣ) if the coefficient is non-zero. Then, enumerate the list Q and establish coefficient equations for each product Hamiltonian in Q by enumerating every instruction in AAIS. During this process, instruction Hamiltonians that contain product Hamiltonians may never appear in Q. These product Hamiltonians are also non-trivial, so they are added to Q. Specifically, for the system instruction, since it is always on, the terms not appearing in Q are forced to have coefficients equaling 0. An example of this procedure is illustrated in FIG. 4. For any instruction ι not appearing in this procedure, force s_{ι}=0.

Because there is no general-purpose solver for mixed-binary non-linear equations, the disclosed technology includes a small solver which uses a relaxation-rounding scheme. A continuous relaxation is applied to loosen the value range of switch variables from [0,1] to [0,1] and solve the equation system by least square methods using a finite-difference scheme via an implementation. Then, the switch variables are rounded according to the solution. Because many instructions contain an amplitude variable as a multiplier to the Hamiltonian, round switch variable s to 1 if abs(s)>δ for a pre-defined small threshold δ and set s=0 otherwise. Then, the equation system is solved again with fixed switch variables to determine the valuation of global and local variables. The solution directly corresponds to the instructions to activate (s_{ι}=1) and the valuation of variables. Using the least square solver, the variables are restrained with lower and upper bounds and set proper initial values. If no solution within an error threshold is found, the site mapping search is returned to, and [symbol] is reported as infeasible.

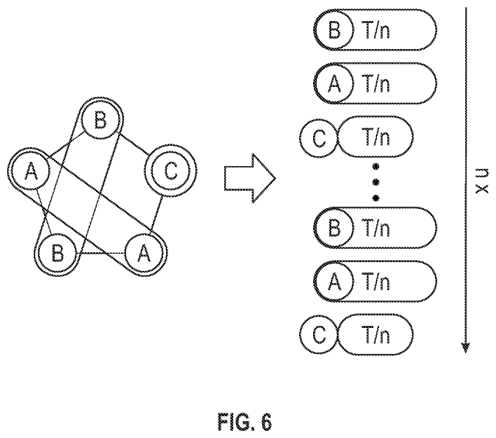

In reference to FIG. 6, conflicting instructions are resolved. To resolve conflicting instructions, a conflict graph may be built for C=(V,E) where V={ι|s_{ι}=1} and E={(ιᵢ,ιⱼ)|ιᵢ conflicts with ιⱼ}. Next, V is divided into S subsets U₁, . . . , U_{S} where E|_{U}_{ᵢ}≙{(ι₁,ι₂)|ι₁,ι₂∈U}={ } for any i. This is effectively a graph vertex coloring problem, and employs a greedy graph coloring algorithm from Network X to find a feasible division. Notice that for each Uᵢ, there is no conflicting instruction pair, so one can construct a valid instruction schedule [symbol] _{U}_{ᵢ}_{,t} to evolve under H_{U}_{ᵢ}=Σ_{ι∈U}_{ᵢ}H_{(ι,v)} for time duration t. Then, Trotterization is applied to approximate the required evolution under Hₜₐᵣ=Σᵢ₌₁^{K}H_{U}_{ᵢ} by sequentially evolving under H_{U}_{ᵢ}. According to the Lie-Trotter formula:

$${e}^{{\sum }_{j} {A}_{j}} = {lim}_{n \to ∞} {( {\prod }_{j} {e}^{{A}_{j} / n} )}^{n} \qquad ( Eqn . 16 )$$

Divide the total evolution time T into n pieces, where n is the Trotterization number pre-defined by users. Sequentially evolve H_{U}_{ᵢ} for time duration T/n and repeat this process n times. Let [symbol] ₁→ [symbol] ₂ represent the instruction schedule obtained by appending [symbol] ₂ after [symbol] ₁. A valid instruction schedule approximating the evolution of Hₜₐᵣ for duration T is characterized by:

[symbol]

=( [symbol] _{U}_{₁}_{,T/n}→ . . . → [symbol] _{U}_{_{S}}_{,T/n})→ . . . →( [symbol] _{U}_{₁}_{,T/n}→ . . . → [symbol] _{U}_{_{S}}_{,T/n}) (Eqn. 17)

which combines n repetitions of the instruction schedule simulating H_{U}_{ᵢ} for duration T/n sequentially for 1≤i≤S. Ideally, when n tends to infinity, the evolution is perfectly simulated. Practically, n should not be too large because of overhead costs in the instruction implementation.

At the start of compilation, a continuous Hamiltonian H(t) is discretized into a piecewise constant Hamiltonian. For multiple pieces of evolution, the compiler 120 deals with them sequentially using the above procedures. Notice that for each piece, the local variables and switch variables have new copies specified for this piece. However, they share the same set of global variables in the coefficient equation system since global variables are fixed before evolution starts.

In general, compiling a target system is computationally hard. For machines with specific topology, finding a site mapping can be as hard as the sub-graph isomorphism problem, an NP-complete problem. Besides, since in the design of AAIS there are no strict restrictions on the expression, pathological functions may emerge in the coefficient of product Hamiltonian terms, which complicates the equation-solving process. Solutions to these problems are not optimal but feasible and efficient enough for most cases.

If the compilation process succeeds in compiling evolution under Hₜₐᵣ(t)=Σₖ₌₁^{K}αₖ(t)Hₖ for duration T, the compiler 120 generates a site mapping [symbol] and a schedule [symbol] approximating evolution under [symbol] (Hₜₐᵣ(t)). The approximation errors are analyzed between the target and synthesized evolution (represented by unitary matrices) produced in the discretization procedure and the compilation procedure. The errors come from discretization, the equation solver, and Trotterization, and the errors decrease when increasing the discretization number, improving the compilation solver, or increasing the Trotterization number, respectively, implying the soundness of the compilation process.

A piecewise constant discretization of Hₜₐᵣ(t) to \tilde{H}(t)=Σₖ₌₁^{K}\tilde{α}ₖ(t)Hₖ is applied. It is assumed that αₖ(t) are piecewise L-Lipschitz functions. Thus, evolution duration is T and the discretization number is D. Formally:

$${\tilde{α}}_{k} ( t ) = {\sum }_{j = 0}^{D - 1} {\tilde{α}}_{k , j} {[ \frac{T}{D} \cdot j , \frac{T}{D} \cdot ( j + 1 ) )}_{} ( t ) , {\tilde{α}}_{k , j} = {\tilde{α}}_{k} ( j \cdot T / D ) \qquad ( Eqn . 18 )$$

where [symbol] _{[a,b)} is the indicator function of set [a,b).

The difference between the unitary U(T) of evolution under [symbol] (Hₜₐᵣ(t)) for duration T and the unitary Ũ(T) of evolution under [symbol] (\tilde{H}(t)) is bounded by:

∥U(T)−Ũ∥≤C₁D⁻¹LKT²≙ε₁ (Eqn. 19)

Here ∥⋅∥ is the spectral norm of matrices, C₁>0 is a constant, D is the discretization number, and L is the Lipschitz constant for αₖ(t), K is the number of terms in H(t), T is the evolution duration.

Thus, when increasing the discretization number D, the evolution error can be arbitrarily small, justifying the method of discretization.

In the compiler 120, a mixed-binary equation solver is used to synthesize piecewise constant \tilde{H}(t). Since the solution is numerical, errors in the evolution are induced by errors in the synthesis. Let the synthesis result be Ĥ(t). Notice that each equation built from Algorithm 1 effectively is Ĥ(t)[P]= [symbol] (\tilde{H}(t))[P] for each piece and each product Hamiltonian P, to conclude:

If the compilation procedure succeeds, the difference between the unitary Ũ(T) and the unitary Û(T) of evolution under Ĥ(t) is bounded by:

∥Ũ(T)−Û(T)∥≤C₂ΔET≙ε₂ (Eqn. 20)

Here C₂>0 is a constant, Δ=max_{t,P}∥Ĥ(t)[P]− [symbol] (\tilde{H}(t))[P]∥ is the error of the equation solution, E is the number of equations built from Algorithm 1, and T is the evolution duration. In aspects, if the solver finds a precise solution, the error in this step decreases.

The Trotterization technique resolves conflicts while also introducing errors. For the constant piece of Ĥ at time slice t, divide the activating instructions into Sₜ groups without conflicts, realizing \check{H}_{t,i} such that Σᵢ₌₁^{S}^{ₜ}\check{H}_{t,i}=Ĥ(t). When the Trotterization number is set to N, the system evolves under each group for duration T/DN sequentially with arbitrary order and repeats this procedure N times.

The difference between Û(T) and the unitary \check{U}(T) of evolution after Trotterization is bounded by:

$$‖ \hat{U} ( T ) - {U}^{⋁} ( T ) ‖ \leq \frac{{( Λ T )}^{2}}{DN} {e}^{\frac{Λ T}{DN}} {=}^{△} {ε}_{3} \qquad ( Eqn . 21 )$$

Here Λ=maxₜSₜ∥ [symbol] ∥, T is the evolution duration, D is the discretization number, and N is the Trotterization number.

As implied by this lemma, increasing the Trotterization number reduces the induced error, and the error can be arbitrarily small.

Combining the above three lemmas via the union bound, the following theorem bounds the total error, implying the soundness of the compilation: if the mixed equation solver finds a precise solution and the discretization and Trotterization numbers are sufficiently large, ideally, the generated instruction schedule simulates Hₜₐᵣ(t).

The error in compilation is bounded by ∥U(T)−\check{U}(T)∥≤ε₁+ε₂+ε₃.

Because the underlying pulse implementation of an instruction evolving for duration t in [symbol] does not necessarily have length t and may break synchronicity, instruction schedules [symbol] are implemented more flexibly. Abstract schedules 125 (FIG. 3) that include the valuation of the variables and the temporal relations between blocks of instruction relax the fixed time slot of instruction calls in instruction schedules. The AAIS 118 of the machine is exposed to abstract schedules 125, but concrete instruction implementations 127 are implicit.

The basic unit of an abstract schedule 125 is an instruction block containing an evolution time t and non-conflicting instructions with the valuation of their local variables. The instructions in a block are intended to simultaneously activate for duration t.

The temporal relations form a directed acyclic graph whose vertices are the instruction blocks. An edge (i→j) represents a restraint: the block j start after the execution of block i. One may extract instruction schedules from an abstract schedule by scheduling the instruction blocks according to the temporal relations.

The concrete schedule 127 is a time schedule specifying the starting and ending time of each instruction call on the real machine. Determining exact timing necessitates instruction implementation details, and the compiler 120, therefore, requires backend machine (i.e., programmable quantum device 112) details. By using a platform-dependent machine object to convert each instruction call into an equivalent schedule, objects specifying the exact instruction execution duration on the real machine can be blocked. Then, a simple scheduler 126 may be used to produce a concrete schedule from the directed acyclic graph of schedule blocks. scheduler 126 traverses the DAG in topological order and schedules each instruction for execution on the appropriate machine signal line at the first available time slot. Visiting each schedule block in topological order ensures that signal line reservations are made in a valid temporal order, and the greedy scheduling approach ensures that the execution order fulfills all temporal dependencies.

In aspects, this scheduling process may be independently configured and optimized, and scheduler 126 may use any number of other criteria to determine the traversal order of instruction blocks or the alignment of blocks within the scheduled order. This freedom in the scheduling process may be leveraged to reduce crosstalk between the blocks or save basis change overhead.

Referring again to FIG. 3, system 100 transpiles, via a transpiler 128, a concrete schedule 127 into a generalized pulse schedule and produces an equivalent platform-dependent executable pulse schedule 110. The generalized pulse schedule stores a control pulse for a given signal line as a list of variable waveforms. Each waveform tracks the time evolution of controllable local variables specified by instructions on that signal line. Then, leverage a platform-dependent machine object to convert a generalized pulse program into a format specified by a pulse-enabled quantum device provider for execution on a real machine.

There are few pulse-enabled quantum device providers, and programming pulses is a challenging endeavor that requires extensive platform knowledge of a variety of hardware and software engineering considerations. Nonetheless, the effectiveness of system 100 is demonstrated by the interoperability and output as a quantum circuit.

For some quantum devices, such as Rydberg systems, the generalized pulse schedules are converted to a specified program. The magnitude variable waveforms and atom position global variables have native correspondences to the values specified in control pulses and control parameters sent to the machine, so the conversion is performed trivially.

On other quantum devices, such as superconducting systems, the generalized pulse schedules are converted into a different specified program. The magnitude variable waveforms build signal envelopes for control pulses sent to the device and insert software-implemented “free Z” rotations at time indices where the phase variable waveforms change in value. If the program supports pulse-level engineering and provides more freedom than another native gate set, the pulse programs may be constructed from more optimized operations and produce shorter pulse programs than the default compilation. In particular, this generates better pulse realizations of evolution under XᵢXⱼ, YᵢYⱼ, and ZᵢZⱼ.

If a quantum device does not provide pulse-level programmability for ion trap devices, the system generates quantum circuits with rotation gates R_{X}, R_{Z}, R_{XX}, R_{YY}, R_{ZZ} and sends these circuits to other compilers and devices. For example, the evolution of under XᵢXⱼ for duration T is realized by R_{XX}(2T) applying on qubits i and j.

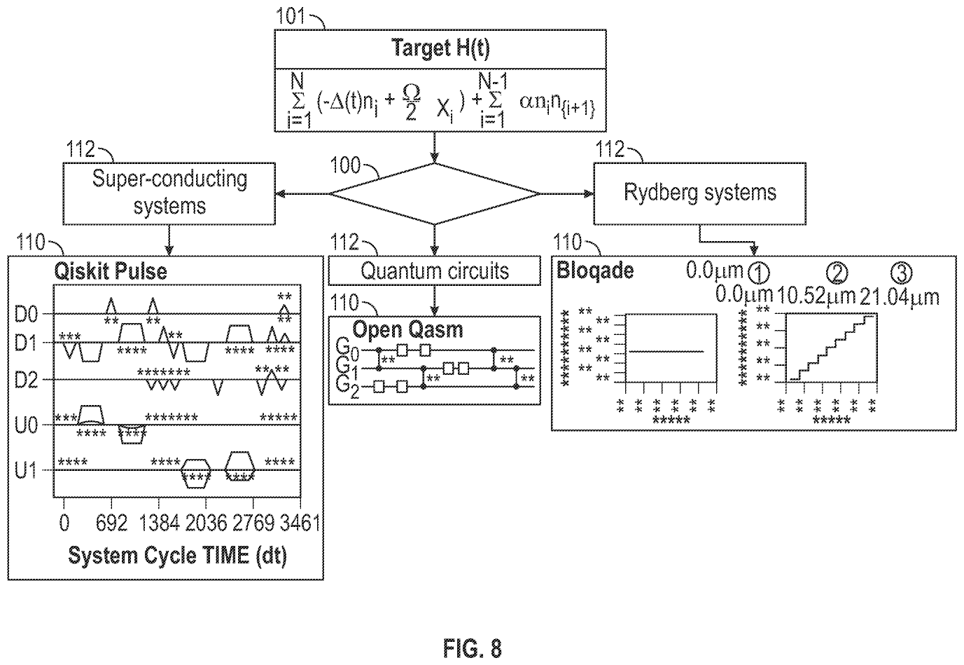

In reference to FIG. 8, several case studies on the evolutions and devices highlight the system's portability, pulse performance, flexibility, and scalability.

The implementation treats time-independent Hamiltonians in standard forms as linear combinations of product Hamiltonians. Expressions of Hamiltonians can be expanded by the distributive laws and eventually into the standard form. Hamiltonians are stored in a list of pairs consisting of product Hamiltonians and coefficients. Product Hamiltonians are realized as tuples of operators on each site. An Expression class deals with the calculus of functions of valuations of local and global variables, and they work as coefficients of product Hamiltonians for parameterized Hermitians.

An example simplified Hamiltonian encoding of the maximal independent set (MIS) problem is described. For G=(V,E), the MIS problem asks for the maximal subset V′ of V such that no edges in E connect two vertices in V′. The problem can be encoded in the evolution initiated at |0 [symbol] under the Hamiltonian:

$${H}_{MIS} ( t ) = {\sum }_{i = 1}^{N} ( - δ ( t ) {\hat{n}}_{i} + \frac{ω}{2} {X}_{i} ) + {\sum }_{( i , j ) ∈ E} α {\hat{n}}_{i} {\hat{n}}_{j} \qquad ( Eqn . 22 )$$

for N=|V|, time interval [0,1], and δ(t)=(−1+2t)U. Here U, ω, and α are real amplitude constants designed in the encoding. The measurement result of the quantum state at the end of the evolution encodes an approximate maximum independent set of the graph (after post-processing).

The model may be instantiated on a chain of three vertices and set U=1 and ω=α=4, and compiled to different machines.

The relative errors are considered when compiling H_{MIS} on each device. The summed error is the summation of differences over the histogram in the simulation to the ground truth, and the relative error is the summed error over the sum of entries in the ground truth histogram. Since H_{MIS} has a very similar structure to the Rydberg system Hamiltonian, the compiled simulation is very close to the ground truth, with a 1.14% relative error. For IBM machines, the simulation is discrete since the instructions are derived. The discretization and machine noises induce significant differences from the ground truth probability, with an 8.30% relative error. The Hamiltonian is also compiled to quantum circuits, setting the Trotterization number to 10. With an ideal simulator, the relative error is 1.67%. The results from all platforms are close to the ground truth; however, the simulation results may have larger errors on real devices where noise is significant.

Bypassing the gate abstraction guides one to prioritize reducing total pulse duration. IBM's® Qiskit® has a circuit compiler that supports rotation gates realizing evolutions under both ZᵢZⱼ and Xᵢ and can construct the evolution U. Their compilation translates a ZᵢZⱼ rotation gate into multiple single-qubit rotations and two cross-resonance gates, incurring a large overhead cost. To reduce total pulse duration, compiler 120 implements the evolution under ZᵢZⱼ with a dynamic duration cross-resonance evolution surrounded by single-qubit gates performing a basis change. This approach generates a significantly shorter pulse than Qiskit's® compilation, particularly when the desired evolution time is short. For evolution under Z₀Z₁ for duration 1, the pulse generated by system 100 is 51% shorter in duration. Though the single gate fidelity may decrease, this approach is beneficial when a program requires a large number of short evolution instructions, as this approach can dramatically lower the total program duration and thereby mitigate decoherence over time. This is illustrated with an experiment using a quantum approximate optimization algorithm (QAOA) to solve the Max-Cut problem.

The Max-Cut problem asks for a separation V′ of an unweighted graph G=(V,E) such that the edges between V′ and V\V′ are maximized. By quantum annealing, alternately simulating the evolution of the initial state |+ [symbol] ⁿ under θⱼH₁ and γⱼH₂ for fixed duration may generate solutions to the Max-Cut problem, where:

H₁=Σ_{(i,j)∈E}ZᵢZⱼ, H₂=Σᵢ₌₁^{N}Xᵢ (Eqn. 23)

Here {θⱼ}ⱼ₌₁^{p} and {γⱼ}ⱼ₌₁^{p} are pre-defined parameters from the algorithm, and N=|V|. QAOA searches for the optimal evolution durations θ and γ to maximize the expected cut size R(s)=Σ_{(i,j)∈E}[sᵢ≠sⱼ], where s is the measurement outcome at the end.

The problem is instantiated with a 12-vertex cycle graph, layer p=1,2,3, and θ,γ set to optimal parameters found by a classical simulator. The solution significantly reduces the pulse duration with an average 59% reduction. The pulse programs are then executed by both methods on IBM's® real machine. On average, the system 100 pulses produce errors 22% less often than Qiskit® pulses. This demonstrates the disclosed system's 100 performance advantage and the necessity of pulse-oriented compilation.

System 100 can also be leveraged to suggest the future design of machine functionalities because of its flexibility in supporting new machines.

For example, take a hypothetical machine in correspondence with IBM's® superconducting machine whose AAIS matches that of IBM's® machine but with all instructions made native. Since XᵢXⱼ, YᵢYⱼ, and ZᵢZⱼ are hypothetically assumed native, the instructions are simultaneously applied, even when multiple instructions affect the same site. Furthermore, they require no change of basis operations in their implementation and pulse realization. The pulse duration of the QAOA example above is reduced by 66.8%, suggesting the benefits of designing such instructions. To further illustrate the benefits of these hypothetical native instructions, the Heisenberg model is compiled:

H_{Heis}=Σ_{(i,j)∈E}(JₓXᵢXⱼ+J_{y}YᵢYⱼ+J_{z}ZᵢZⱼ)+Σᵢ₌₁^{N}cZᵢ (Eqn. 24)

Here, Jₓ, J_{y}, J_{z}, and c are parameters modeling magnetic interactions, and E is a graph topology. By instantiating this model on a graph matching the machine topology of a 7-qubit IBM® machine and compiling the model to both the real and hypothetical machines, the results show that the pulse duration on the hypothetical machine is reduced by 66.4%.

Scalability of the compiler 120 (FIG. 1) is demonstrated by compiling many models of different sizes, topology, and discretization numbers, presented in Table 1 and Table 2.

The difficulty of this task mainly stems from four aspects. First, searching for a site mapping requires a subgraph isomorphism, an NP-complete problem asking for a subgraph in the machine topology graph matching the topology of the target Hamiltonian. Second, many quantum physics effects have highly non-linear dependencies on the controllable parameters, making the Hamiltonian synthesis hard. Third, the generality to compile all kinds of Hamiltonians unavoidably requires a large number of equations built for synthesis. Lastly, there are often many configurable parameters on a machine, creating a huge search space. Although the task is hard, for many problems, the compiler 120 succeeds in a reasonable time, automatically generating executable pulses in several minutes.

The effect of topology and machine sizes has an effect on the compilation time of the MIS Hamiltonians through the system 100. The discretization number is set to 1. Three kinds of topologies E are used: chains, cycles, and grids. The compilation times are presented in Table 1. For a typical IBM® machine topology, it is easy to find a site mapping for a chain, hard for a cycle, and impossible for a grid. Furthermore, these compilations require a large number of equations. To synthesize a 40-vertex chain on a 127-qubit IBM machine, 862 equations are built upon 1771 variables, which on average takes around 2 minutes to solve. Similarly, while compilation to small Rydberg systems is fast, solving for atom positions in large Rydberg systems is hard without heuristics because of the highly non-linear interaction strength and the large search space. In contrast, IonQ® machines have full connectivity, so site mapping is trivial and the compilation is fast. However, because their machines have at most 21 qubits, compilation for problems with more than 21 sites fails.

TABLE 1

| | Chain (N) | | | | Cycle (N) | | | | Grid (N × N) | |
|---|---|---|---|---|---|---|---|---|---|---|
| | 6 | 12 | 20 | 40 | 6 | 12 | 20 | 40 | 3 × 3 | 4 × 4 |
| Bloqade | 0.257 | 1.28 | 4.03 | 83.8 | 0.471 | 14.6 | 573 | >1000 | 143 | >1000 |
| IBM Pulse | 3.43 | 5.34 | 10.5 | 151 | N.A. | 5.66 | 13.3 | >1000 | N.A. | N.A. |
| IonQ Circuit | 0.678 | 4.43 | 43.7 | N.A. | 0.676 | 6.74 | 33.8 | N.A. | 2.64 | 15.46 |

TABLE 2

| | MIS (D) | | | | QAOA (D) | | | | Heis (D) |
|---|---|---|---|---|---|---|---|---|---|
| | 1 | 5 | 10 | 20 | 1 | 5 | 10 | 20 | 1 |
| Bloqade | 2.00 | 24.0 | 80.2 | 334 | N.A. | N.A. | N.A. | N.A. | N.A. |
| IBM Pulse | 8.7 | 32.7 | 70 | 156 | 4.13 | 21.4 | 37.9 | 115 | 1.34 |
| IonQ Circuit | 13.7 | 57.4 | 111 | 167 | 7.67 | 36.8 | 98.1 | 216 | 1.19 |

Second, after testing the effect of the discretization number and different Hamiltonians on the compilation time, the results are detailed in Table 2. The system is applied to compile the MIS Hamiltonian, Max-Cut QAOA evolution, and Heisenberg model to the machines using different discretization numbers D. The compilation times for IBM® machines and IonQ® machines are almost linear in the discretization number because they do not have global variables, so each piece of constant Hamiltonian evolution can be dealt with independently. For Rydberg systems, the time complexity has a higher-order dependency on the discretization number because the presence of global variables requires all pieces to be solved together. The compilations for QAOA evolution and the Heisenberg model fail for Rydberg systems because of a lack of engineered pulses realizing single-site evolution.

The disclosed system 100 for quantum simulation is the technology architecture to consider quantum simulation and compilation to multiple platforms of analog quantum devices (which in some cases are disperate). In addition to the simulation, the disclosed system 100 provides the benefit of being able to write once and run anywhere. Compiler 120 provides the benefit of being the first compiler of its kind to generate pulse schedules of analog quantum devices for desired quantum simulation problems.

Referring to FIG. 11, method 400 for quantum simulation for the system 100 of FIG. 1 is shown. System 100 for quantum simulation includes a processor and a memory, including instructions stored thereon, which, when executed by the processor 210, cause the controller 200 to perform the steps of method 400.

At step 402, processor 210 causes the system 100 to access via a user interface a Hamiltonian equation. For example, a user may construct a Hamiltonian equation and enter it via a user device, such as a tablet. In aspects, a user interface is not required, for example, compilation may be scripted, programmatic, and otherwise automated.

Next, at step 404, processor 210 causes the system 100 to access via the user interface a selection of a target quantum device 112 (FIG. 8). For example, a user may select a Rydberg system as the target quantum device using a user interface, or the device may be preselected. For example, the selection may happen using an application on a user device.

Next, at step 406, the processor 210 causes the system 100 to access an abstract analog instruction set, which is designed specifically for each device. The abstract analog instruction set is configured to cause an evolution in the selected target quantum device. The memory stores the information about the analog instruction sets and the mapping from the analog instruction set to the pulse schedules so that they can be accessed by the processor.

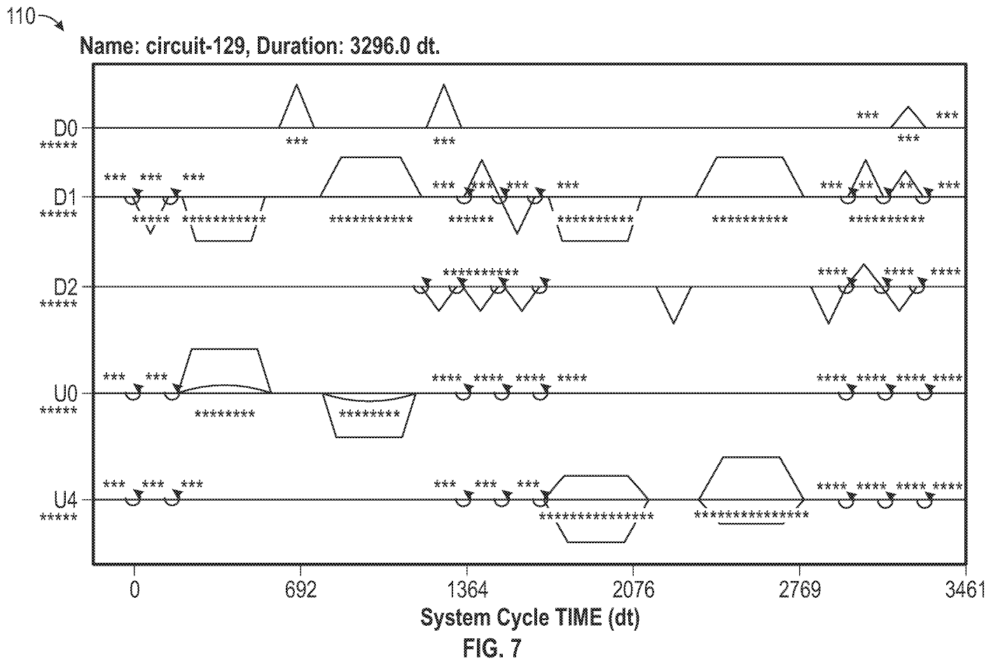

Next, at step 408, processor 210 causes the system 100 to compile the Hamiltonian equation to generate a pulse schedule 110 (FIG. 7) based on the compiled Hamiltonian equation for the target quantum device 112. In aspects, the Hamiltonian equation may be compiled to multiple platforms, including, for example, QuEra's® Rydberg atom arrays, IBM's® transmon qubit systems, and IonQ's® trapped ion systems. In aspects, the target devices may include a processor, such as an FPGA configured to communicate with the system 100. The FPGA may receive the pulse schedule and generate physical pulses (e.g., microwave pulses and/or lasers) that interact with the physical system.

Since different devices have different properties that affect the compiler's 120 efficiency, compilation passes may be used that are specifically tailored for each type of device. A brute-force search with heuristics to find a site mapping is used as an example, but other pruning techniques are contemplated. In aspects, the mixed-binary equation solver may be optimized according to the structure of the problem. In aspects, other compilation techniques, such as synthesizing Hamiltonians not appearing directly in the given AAIS with a combination of instruction calls is also contemplated.

Next, at step 410, processor 210 causes the system 100 to transmit the pulse schedule 110 to the target quantum device 112 (FIG. 8) to create an evolution in the target quantum device 110.

Certain aspects of the present disclosure may include some, all, or none of the above advantages and/or one or more other advantages readily apparent to those skilled in the art from the drawings, descriptions, and claims included herein. Moreover, while specific advantages have been enumerated above, the various aspects of the present disclosure may include all, some, or none of the enumerated advantages and/or other advantages not specifically enumerated above.

The aspects disclosed herein are examples of the disclosure and may be embodied in various forms. For example, although certain aspects herein are described as separate aspects, each of the aspects herein may be combined with one or more of the other aspects herein. Specific structural and functional details disclosed herein are not to be interpreted as limiting, but as a basis for the claims and as a representative basis for teaching one skilled in the art to variously employ the present disclosure in virtually any appropriately detailed structure. Like reference numerals may refer to similar or identical elements throughout the description of the figures.

The phrases “in an aspect,” “in aspects,” “in various aspects,” “in some aspects,” or “in other aspects” may each refer to one or more of the same or different example aspects provided in the present disclosure. A phrase in the form “A or B” means “(A), (B), or (A and B).” A phrase in the form “at least one of A, B, or C” means “(A); (B); (C); (A and B); (A and C); (B and C); or (A, B, and C).”

It should be understood that the foregoing description is only illustrative of the present disclosure. Various alternatives and modifications can be devised by those skilled in the art without departing from the disclosure. Accordingly, the present disclosure is intended to embrace all such alternatives, modifications, and variances. The aspects described with reference to the attached drawing figures are presented only to demonstrate certain examples of the disclosure. Other elements, steps, methods, and techniques that are insubstantially different from those described above and/or in the appended claims are also intended to be within the scope of the disclosure.

What is claimed is:

1. A system for quantum simulation, the system comprising:
a processor; and
a memory, including instructions stored thereon, which, when executed by the processor, cause the system to:
obtaining a Hamiltonian equation;
obtaining a selection of a target quantum device;
access an abstract analog instruction set configured to cause an evolution in the selected target quantum device; and
compile the Hamiltonian equation to generate a pulse schedule based on the abstract analog instruction set for the target quantum device.

2. The system of claim 1, wherein the instructions, when executed by the processor, further cause the system to:
transmit the pulse schedule to the target quantum device to create an evolution in the target quantum device.

3. The system of claim 1, wherein the target quantum device is one of a plurality of quantum devices.

4. The system of claim 1, wherein the pulse schedule includes one or more patterns of analog pulses.

5. The system of claim 1, wherein programming the target quantum device comprises:
transmitting signals in the form of pulses through one or more signal carriers.

6. The system of claim 5, wherein the signals are configurable through parameters including at least one of amplitude over time or phase over time.

7. The system of claim 5, wherein the one or more signal carriers are abstracted as signal lines.

8. The system of claim 5, wherein each signal line includes instructions to represent the signals sent through the signal carriers.

9. The system of claim 8, wherein at each point in time the signal line carries no more than one instruction of the instruction.

10. The system of claim 1, wherein when compiling the Hamiltonian equation, the instructions, when executed by the processor, further cause the system to:
declare zero, one or more local variables that are tuned for each invocation when compiling the target Hamiltonian.

11. The system of claim 1, wherein Hamiltonians used in the Hamiltonian equation are stored in a dictionary as linear combinations of product Hamiltonians.

12. The system of claim 1, wherein the analog instruction set includes one or more site identifiers in a set to represent qubit sites of the target quantum device.

13. A processor-implemented method for quantum simulation, the method comprising:
obtaining a Hamiltonian equation;
obtaining a selection of a target quantum device;
accessing an abstract analog instruction set configured to cause an evolution in the selected target quantum device; and
compiling the Hamiltonian equation to generate a pulse schedule based on the abstract analog instruction set for the target quantum device.

14. The processor-implemented method of claim 13, further comprising transmitting the pulse schedule to the target quantum device to create an evolution in the target quantum device.

15. The processor-implemented method of claim 13, wherein the target quantum device is one of a plurality of quantum devices.

16. The processor-implemented method of claim 13, wherein the pulse schedule includes one or more patterns of analog pulses.

17. The processor-implemented method of claim 13, wherein programming the target quantum device comprises:
transmitting signals in the form of pulses through one or more signal carriers.

18. The processor-implemented method of claim 17, wherein the signals are configurable through parameters including at least one of amplitude over time or phase over time.

19. The processor-implemented method of claim 17, wherein the analog instruction set includes one or more site identifiers in a set to represent qubit sites of the target quantum device.

20. A non-transitory computer-readable storage medium storing a program for causing a processor to execute a method of quantum simulation, the method comprising:
obtaining a Hamiltonian equation;
obtaining a target quantum device;
accessing an abstract analog instruction set configured to cause an evolution in the target quantum device; and
compiling the Hamiltonian equation to generate a pulse schedule based on the abstract analog instruction set for the target quantum device.
